(19) United States
(12) Patent Application Publication
(10) Pub. No.: US 2026/0015488 A1
(43) Pub. Date: Jan. 15, 2026

(54) INSULATIVE COMPOSITES AND ARTICLES MADE THEREFROM

(71) Applicant: W. L. Gore & Associates, Inc., Newark, DE (US)

(72) Inventors: Paul Bielewicz, Newark, DE (US); Edward Neitzel, Newark, DE (US); Edward Rubin, Newark, DE (US); Jeffrey A. Knopf, Wilmington, DE (US)

(21) Appl. No.: 19/137,127

(22) PCT Filed: Dec. 8, 2023
(86) PCT No.: PCT/US2023/083058

§ 371 Date: Jun. 9, 2025

Related U.S. Application Data
(60) Provisional application No. 63/431,563, filed on Dec. 9, 2022.

(51) Int. Cl. C08K 7/26; C08K 3/34; C08K 7/14; F16L 59/02; H01M 10/658

(52) U.S. Cl. CPC C08K 7/26; C08K 3/34; C08K 7/14; F16L 59/028; H01M 10/658; C08K 2201/014

(57) ABSTRACT

Insulative composites as well as articles formed therefrom are described herein. The insulative composites include a fibrillated polymer matrix, insulative particles, and additional particulate components such as at least one of reinforcement fibers, expandable microspheres, and opacifiers. The insulative particles and additional particulate components are durably enmeshed within the fibrillated polymer matrix. The insulative composites act as a heat propagation barrier when exposed to temperatures sufficient to partially or completely volatilize the fibrillated polymeric matrix within the insulative composite. The insulative composite is suitable for use in applications and/or in articles that have at least one thermally sensitive component that is capable (generally upon failure of that component) of releasing energy that is sufficient to result in a temperature that partially or completely volatilizes the fibrillated polymer matrix within the insulative composite yet still provides a sufficient insulative effect to protect one or more adjacent thermally sensitive components from damage.

### CROSS-REFERENCE TO RELATED APPLICATION

This application is a national phase application of PCT Application No. PCT/US2023/083058, internationally filed on Dec. 8, 2023, which claims the benefit of U.S. Provisional Application No. 63/431,563, filed Dec. 9, 2022, which are herein incorporated by reference in their entireties for all purposes.

### FIELD

The present disclosure relates generally to insulative materials and articles thereof, and more specifically, to insulative composites and articles made therefrom that are able to maintain insulative and thermal barrier properties when exposed to high temperatures.

### BACKGROUND

High temperature insulative materials are often incorporated into electronic devices to protect sensitive components located therein or to protect the user from a heat source emanating uncomfortable heat to the user. Certain applications, such as battery cell packs, may benefit from using high temperature insulative materials that can also function as a high temperature insulative composite capable of withstanding very high temperatures, such as a thermal runaway event in a lithium-ion battery. However, many conventional insulative materials are difficult to handle, are difficult to form into a desired shape or thickness suitable for the intended application, and/or they may suffer from excessive dusting.

Various protective articles require insulative materials that are thin, strong, conformable, compressible, and have insulative properties (e.g., a thermal conductivity sufficient for the intended use). However, some insulative materials are used in applications or devices where a high temperature event may occur, such as when a component within the device malfunctions and releases an amount of energy sufficient to trigger an adverse event (e.g., a thermal runaway event). The resulting temperature increase could potentially damage other components within or external to the device. In some embodiments, a high temperature event may be sufficient to damage a second component, wherein damage to the second component may trigger a second high temperature event (for example, adjacent cells within a high energy battery (e.g., a lithium-ion battery).

Thus, there remains a need for a high temperature insulative composite that is suitable for use in high temperature applications, that are thin, conformable, thermally insulative, and which can act as a high temperature insulative composite when exposed to high temperatures.

### SUMMARY

According to one Aspect (“Aspect 1”), an insulative composite includes 50 wt % or less of a fibrillated polymer matrix, more than 40 wt % insulative particles, wherein the insulative particles are selected from fumed silica, amorphous silica, colloidal silica, precipitated silica, fused silica, silica gel, silica xerogel, silicates, fumed metal oxides, and combinations thereof, and greater than about 1 wt % of a combined total of additional particulate components selected from one or more opacifier, one or more reinforcement fiber, one or more expandable microsphere, and any combination thereof, where the weight percent is based on the total weight of the final insulative composite, and where the insulative particles and the additional particulate components are durably enmeshed within the fibrillated polymer matrix.

According to another Aspect (“Aspect 2”) further to Aspect 1, where the insulative particles are fumed silica particles.

According to another Aspect (“Aspect 3”) further to Aspect 1 or Aspect 2, where the insulative composite is in the form of a tube, tape or sheet having a thickness or a tube wall thickness of 5 mm or less.

According to another Aspect (“Aspect 4”) further to any one of Aspects 1 to 3, where the fibrillated polymer matrix comprises a polyolefin, an ultrahigh molecular weight polyethylene, a fluoropolymer, polytetrafluoroethylene, expanded polytetrafluoroethylene, a polyurethane, a polyester, a polyamide, or any combination thereof.

According to another Aspect (“Aspect 5”) further to any one of Aspects 1 to 4, where the polymer is polytetrafluorethylene (ePTFE), an ultra-high molecular weight polyethylene (UHMWPE) or a combination thereof.

According to another Aspect (“Aspect 6”) further to any one of Aspects 1 to 5, where the combined total of additional particulate components comprises greater than 1 wt % of one or more opacifier.

According to another Aspect (“Aspect 7”) further to any one of Aspects 1 to 6, where the additional particulate components comprise up to 30 wt % of an expandable microsphere.

According to another Aspect (“Aspect 8”) further to any one of Aspects 1 to 7, where the opacifier is selected from carbon black, titanium dioxide, aluminum oxide, zirconium dioxide, iron oxides, silicon carbide, molybdenum silicide, manganese oxide, a polydialkylsiloxane where the alkyl groups contain 1 to 7 carbon atoms, or any combination thereof.

According to another Aspect (“Aspect 9”) further to any one of Aspects 1 to 8, where the one or more reinforcement fibers comprise carbon fibers, glass fibers, aluminoborosilicate fibers, or a combination thereof.

According to one Aspect (“Aspect 10”), an insulative composite includes less than 50 wt % of a fibrillated polymer matrix, the insulative particles are selected from fumed silica, amorphous silica, colloidal silica, precipitated silica, fused silica, silica gel, silica xerogel, silicates, fumed metal oxides, and combinations thereof, greater than about 1 wt % of at least one opacifier, up to 25 wt % reinforcement fibers, less than 20 wt % expandable microspheres where the weight percent is based on the total weight of the insulative composite article in a final state, and where the insulative particles and the additional particulate components are durably enmeshed within the fibrillated polymer matrix.

According to another Aspect (“Aspect 11”) further to Aspect 10, where the insulative particles are fumed silica particles

According to another Aspect (“Aspect 12”) further to Aspect 10 or Aspect 11, where the insulative composite in the form of a tube, tape or sheet having a thickness or a tube wall thickness of 5 mm or less.

According to another Aspect (“Aspect 13”) further to Aspects 10-12, where the fibrillated polymer matrix comprises a polyolefin, an ultrahigh molecular weight polyethylene, a fluoropolymer, polytetrafluoroethylene, expanded polytetrafluoroethylene, a polyurethane, a polyester, a polyamide, or any combination thereof.

According to another Aspect (“Aspect 14”) further to Aspects 10-13, where the polymer is expanded polytetrafluorethylene (ePTFE), an ultra-high molecular weight polyethylene or a combination thereof.

According to another Aspect (“Aspect 15”) further to Aspects 10-14, where the combined total of additional particulate components comprises greater than 10% of one or more opacifier.

According to another Aspect (“Aspect 16”) further to Aspects 10-15, where the additional particulate components comprise up to 30 wt % of expandable microspheres.

According to another Aspect (“Aspect 17”) further to Aspects 10-16, where the opacifier is selected from carbon black, titanium dioxide, aluminum oxide, zirconium dioxide, iron oxides, silicon carbide, molybdenum silicide, manganese oxide, a poly dialkylsiloxane where the alkyl groups contain 1 to 4 carbon atoms, or any combination thereof.

According to another Aspect (“Aspect 18”) further to Aspects 10-17, where the one or more reinforcement fibers comprise carbon fibers, glass fibers, aluminoborosilicate fibers, or a combination thereof.

According to another Aspect (“Aspect 19”) an article includes the insulative composite of any one of Aspects 1-9.

According to another Aspect (“Aspect 20”) an article includes the insulative composite of any one of Aspects 10-18.

According to another Aspect (“Aspect 21”) the use of the insulative composite of any one of Aspects 1-9 to prevent thermal propagation within a lithium-ion battery.

According to another Aspect (“Aspect 22”) the use of the insulative composite of any one of Aspects 10-18 to prevent thermal propagation within a lithium-ion battery.

According to another Aspect (“Aspect 23”) an article includes a first component capable of a generating a high temperature event comprising a first temperature, an insulative composite positioned between the first element and the second element, the insulative composite having a first side oriented toward the first component and an opposing side oriented towards the second component; the insulative composite including (1) greater than or equal to about 40% wt insulative particles, wherein the insulative particles are selected from fumed silica, amorphous silica, colloidal silica, precipitated silica, fused silica, silica gel, silica xerogel, silicates, fumed metal oxides, and combinations thereof, (2) less than or equal to about 60 wt % of a fibrillated polymer matrix, (3) from 1 wt % to 45 wt % of one or more additional particulate components selected from one or more opacifiers, one or more reinforcement fibers, one or more expandable microspheres, and any combination thereof, where the weight percent is based on the total weight percent of the insulative composite in a final state, and where the insulative particles and the additional particulate components are durably enmeshed within the fibrillated polymer matrix.

According to another Aspect (“Aspect 24”) further to Aspect 23, where the insulative particles are fumed silica particles.

In one Aspect (“Aspect 25”) a multi-layer insulative composite includes a first layer and a second layer, the first layer and the second layer each including (1) greater than or equal to about 40 wt % insulative particles, wherein the insulative particles are selected from fumed silica, amorphous silica, colloidal silica, precipitated silica, fused silica, silica gel, silica xerogel, silicates, fumed metal oxides, and combinations thereof, (2) less than or equal to about 60 wt % of a fibrillated polymer matrix, and (3) from 1 wt % to 45 wt % of one or more additional particulate components selected from one or more opacifiers, one or more reinforcement fibers, one or more expandable microspheres, and any combination thereof such that a total wt % equals 100 wt % where the one or more additional particulate components vary in one or more of chemical composition, particle size, and particle size distribution through a first thickness of the first layer and where the one or more additional particulate components vary in the one or more of chemical composition, the particle size, and the particle size distribution through a second thickness of the second layer.

According to another Aspect (“Aspect 26”) further to Aspect 25, including a third layer including the one or more additional particulate components that vary in the one or more of chemical composition, the particle size, and the particle size distribution through a thickness of the third layer.

According to another Aspect (“Aspect 27”) further to Aspect 25 or Aspect 26, where the one or more additional components is an opacifier and the first layer contains therein the opacifier having a first particle size distribution, the second layer contains therein the opacifier having a second particle size distribution, and the third layer contains therein the opacifier having a third particle size distribution.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1A is a schematic cross-section of an insulative composite having therein varying insulative particles and additional particulate components through a thickness thereof in accordance with some embodiments;

FIG. 1B is a schematic cross-section of a multi-layer insulative composite having therein differing particulate size distributions in different layers in accordance with some embodiments;

FIG. 2 is a schematic illustration of the testing system used to evaluate the performance of samples in the Protective Heat Propagation Barrier Assay in accordance with some embodiments; and

FIG. 3 illustrates is a schematic illustration of a side view of the contact compression zone when testing samples in the Protective Heat Propagation Barrier Assay in accordance with some embodiments.

### DETAILED DESCRIPTION

It should be noted that the accompanying drawing figures referred to herein are not necessarily drawn to scale and may be exaggerated to illustrate various aspects of the present disclosure, and in that regard, the drawing figures should not be construed as limiting.

As used herein, “ultrahigh molecular weight” refers to a polymer having a number average molecular weight in the range of from 1,000,000 to 10,000,000 g/mol. In some embodiments, the number average molecular weight of the polymer may be from 3,000,000 to 10,000,000 or from 5,000,000 to 10,000,000.

Unless specifically noted, the term “weight percent” or “wt %” as used herein is meant to denote the weight percent of that component based on the total weight percent of the final insulative composite (i.e., after lubricant is removed). “Wt %” may be defined as the mass of the component divided by the total mass of the insulative component (after lubricant is removed) multiplied by 100.

As used herein, “additional particulate components” include an opacifier(s), reinforcement fibers, expandable microspheres, and any combination thereof.

As used herein, the term “high temperature” refers to a temperature that is sufficient to partially or completely degrade (e.g., depolymerization, chain scission, and/or volatilization) the fibrillated polymer matrix within the high temperature insulative composites described herein. In one aspect, the “high temperature” is a temperature that is sufficient to partially or completely volatilize the fibrillated polymer within the high temperature insulative composites.

As used herein, the term “high temperature event” is intended to describe a situation where a temperature is achieved that is sufficient to partially or fully volatilize the fibrillated polymer matrix within the high temperature insulative composite.

The insulative composite (1) provides a thermal conductivity prior to exposure to a high temperature event and (2) functions as a protective heat propagation barrier when subjected to a high temperature event where a temperature sufficient to partially or fully volatilize the fibrillated polymer binder within the insulative composite. It is to be understood that the phrases “fibrillated polymer matrix” and “fibrillated polymer binder” may be used interchangeably herein.

The insulative composite is suitable for use in applications and/or in articles that have at least one thermally sensitive component that is capable (generally upon failure of that component) of releasing energy that is sufficient to result in a temperature that partially or completely volatilizes (e.g., degrades) the fibrillated polymer matrix within the insulative composite yet still provides a sufficient insulative effect to protect one or more adjacent thermally sensitive components from damage. This is particularly important in applications/articles where a first high temperature thermal event (typically associated with a failure of a component) having a temperature that is capable of damaging an adjacent thermally sensitive component, which in turn, is capable of generating a second high temperature thermal event, and so on (for example, the propagation of runaway high temperature thermal events in high energy batteries). The insulative composite delays or prevents the propagation of thermal energy from a first side of the insulative composite to a second, opposing side of the insulative composite in a protective fashion such that one or more thermally sensitive components on the second, opposing side of the insulative composite are sufficiently protected from a high temperature thermal event such that adjacent thermally sensitive component(s) do not enter a thermal runaway event or such that a thermal runaway propagation speed is reduced.

In certain applications, such as in certain high energy batteries, a high temperature thermal event may occur. As discussed above, the high temperature thermal event may be sufficient to damage adjacent thermally sensitive components and includes situations where exposure of the adjacent thermally sensitive components to the high temperature event may trigger a secondary high temperature event in adjacent thermally sensitive components (e.g., runaway events in failing lithium-ion batteries). As such, there is a need for an insulative barrier that protects adjacent thermally sensitive components from exposure to high (damaging) temperatures. As demonstrated in the assay described herein, one side (“challenge side”) of a thin sheet (approximately 1 mm thick) of an insulative composite was compressively contacted with an approximately 800° C. heated stainless steel mass (i.e., a temperature sufficient to volatilize the fibrillated polymer). The maximum temperature on the opposing side of the thin sheet (“protected side”) was significantly lower. In one embodiment, insulative composites capable of functioning as a heat propagation barrier are those capable of limiting the maximum temperature on the protected side to 215° C. or less when the challenge side is exposed to a temperature of approximately 800° C. when following the Protective Heat Propagation Barrier Testing Assay described below.

The temperature necessary to partially or fully volatilize the fibrillated polymer binder within the insulative composites will vary with the choice of fibrillated polymer. As such, the insulative composites are those capable of providing at least about 70%, at least about 73%, at least about 75%, at least about 80%, at least about 85%, at least about 90% or at least about 95% (with 100% being the maximum or the total % equals 100%) reduction in observed maximum temperature (i.e., on the protected/insulated side) when subjected to a temperature (i.e., on the challenge side) that at least partially volatilizes the fibrillated polymer matrix. In a further embodiment, the challenge side temperature comprises sufficient thermal energy to completely volatilize the fibrillated polymer matrix.

In another embodiment, the high temperature event includes a temperature that partially or completely volatilizes the fibrillated polymer matrix in an insulative composite material at a temperature of at least about 250° C., at least about 300° C., at least about 350° C., at least about 400° C., at least about 450° C., at least about 500° C., at least about 550° C., at least about 600° C., at least about 650° C., at least about 700° C., at least about 750° C., at least about 800° C. or at least about 850° C. where the maximum temperature on the opposing side of the insulative composite material is no more than about 225° C., no more than about 220° C., no more than about 215° C., no more than about 210° C., no more than about 205° C., no more than about 200° C., no more than about 195° C., no more than about 190° C., no more than about 185° C., no more than about 180° C., no more than about 175° C., no more than about 170° C., no more than about 165° C., no more than about 160° C., no more than about 155° C., no more than about 150° C. or no more than about 145° C. In at least one embodiment, the high temperature thermal event is at least 800° C. on the challenge side of the insulative composite and the maximum temperature on the opposing side (protected/insulated side) of the insulative composite is 215° C. or less.

### Insulative Composites

The insulative composites described herein include a fibrillated polymer matrix, insulative particles, and additional particulate components (e.g., one or more opacifier, reinforcement fibers, expandable microspheres and combinations thereof). In one embodiment, the insulative composite includes more than 1 wt % of a combined total of additional particulate components that include one or more opacifier, reinforcement fiber(s), expandable microsphere(s), and any combination thereof. As set forth above, unless otherwise defined, the term weight percent (wt %) is meant to denote the percent of the total weight of the insulative composite. In another embodiment, the insulative composite includes greater than 1 wt % opacifier(s).

The insulative particles and additional particulate components (i.e., the one or more opacifier and/or the reinforcement fibers and/or the expandable microspheres) are durably enmeshed within the fibrillated polymer matrix. As used herein, the phrase “durably enmeshed” is meant to describe that the insulative particles and the additional particulate components of the insulative composite are non-covalently immobilized within the fibrillated polymer matrix. No separate binder is present to fix or otherwise bind the insulative particles and additional particulate components within the fibrillated polymer matrix. Additionally, it is to be appreciated that in some embodiments, the insulative particles and additional particulate components are located throughout the thickness of the fibrillated polymer matrix of the insulative composite.

The insulative composite may be formed into thin, flexible, compressible, and conformable shapes at least due to the strength of the fibrillated polymer matrix, thereby facilitating the ability to fabricate shaped materials suitable for a target application.

### Insulative Particles

The term “insulative particles” refers to silica-based insulative particles that include at least one of: fumed silica, amorphous silica, colloidal silica, precipitated silica, fused silica, silica gel (excluding any silica aerogel), silica xerogel, silicates (such as calcium silicate), fumed metal oxides (such as fumed alumina, fumed titania, fumed blends of silica/alumina/titania, and combinations thereof. In one embodiment, the thermally insulative particles may be modified to contain functional groups to alter the relative hydrophilicity/hydrophobicity of the particles (e.g., fumed hydrophobic silica). In another embodiment, the “insulative particles” consist of fumed silica particles, amorphous silica particles, hydrophobic silica particles, precipitated silica particles, fused silica particles, silica gel particles (excluding silica aerogel), silicate particles (such as calcium silicate particles), and any combination thereof. In a further embodiment, the “insulative particles” may consist solely of fumed silica particles.

The amount of silica-based insulative particles present within the insulative composite may be at least 1 wt % (based on the total weight of insulative particles), at least 2 wt %, at least 3 wt %, at least 4 wt %, at least 5 wt %, at least 6 wt %, at least 7 wt %, at least 8 wt %, at least 9 wt %, at least 10 wt %, at least 20 wt %, at least 30 wt %, at least 40 wt %, at least 50 wt %, at least 60 wt %, at least 70 wt %, at least 80 wt %, at least 90 wt %, at least 95 wt %, or at least 99 wt %. In some embodiments, the silica-based insulative particles are present within the insulative composite in an amount from about 1 wt % to about 100 wt %, from about 5 wt % to about 100 wt %, from about 10 wt % to about 100 wt %, from about 20 wt % to about 100 wt %, from about 30 wt % to about 100 wt %, from about 40 wt % to about 100 wt %, from about 50 wt % to about 100 wt %, from about 60 wt % to about 100 wt %, from about 70 wt % to about 100 wt %, from about 80 wt % to about 100 wt %, or from about 90 wt % to about 100 wt %. In other embodiments, the silica-based insulative particles may be present in the insulative composite in an amount from about 40 wt % to about 99 wt %, from about 40 wt % to about 95 wt %, from about 50 wt % to about 95 wt %, from about 60 wt % to about 95 wt %, from about 70 wt % to about 95 wt %, from about 80 wt % to about 95 wt %, or from about 90 wt % to about 95 wt %. In further embodiments, the insulative particles may be present in the insulative composite in an amount from about 1 wt % to about 80 wt %, from about 2 wt % to about 80 wt %, from about 3 wt % to about 80 wt %, from about 4 wt % to about 80 wt %, from about 5 wt % to about 80 wt %, from about 6 wt % to about 80 wt %, from about 7 wt % to about 80 wt %, from about 8 wt % to about 80 wt %, from about 9 wt % to about 80 wt %, from about 10 wt % to about 80 wt %, from about 20 wt % to about 80 wt %, from about 30 wt % to about 80 wt %, from about 40 wt % to about 80 wt %, from about 50 wt % to about 80 wt %, from about 60 wt % to about 80 wt %, or from about 70 wt % to about 80 wt %. In some embodiments, the silica-based insulative particles may be solely present in the insulative particles. The silica-based insulative particles may be or include fumed silica.

### Opacifiers

In one embodiment, the insulative composite includes at least one opacifier, and the opacifier may be present in the insulative composite outside of the additional insulative particulates. Opacifiers reduce radiative heat transfer and improve thermal performance. Non-limiting examples of suitable opacifiers for use in the insulative composite include, but are not limited to, carbon black, titanium dioxide, iron oxides, silicon carbide, molybdenum silicide, manganese oxide, polydialkylsiloxanes having alkyl groups containing 1 to 4 carbon atoms, or any combination thereof. In one embodiment, the opacifier may be used in the form of a finely dispersed powder. In at least one embodiment, the amount of opacifier present in the insulative composite (based on the total weight of the insulative composite) may be up to about 60 wt %. In some embodiments, the opacifier(s) is present in the insulative composite (based on the total weight of the insulative composite) in an amount greater than about 1 wt %.

In some embodiments, the opacifier(s) is present in the insulative composite (based on the total weight of the insulative composite) in an amount greater than about 10 wt %. In some embodiments, the amount of opacifier(s) present in the high temperature insulative composite may be from about 1 wt % to about 60 wt % (based on the total weight of the insulative composite), from about 3 wt % to about 60 wt %, from about 5 wt % to about 60 wt %, from about 7 wt % to about 60 wt %, from about 10 wt % to about 60 wt %, from about 15 wt % to about 60 wt %, from about 20 wt % to about 60 wt %, from about 25 wt % to about 60 wt %, from about 30 wt % to about 60 wt %, from about 35 wt % to about 60 wt %, from about 40 wt % to about 60 wt %, from about 45 wt % to about 60 wt %, or from about 50 wt % to about 60 wt %. In some embodiments, the opacifier(s) may be present in the insulative composite in an amount from about 1 wt % to about 45 wt % (based on the total weight of the insulative composite), from about 3 wt % to about 45 wt %, from about 5 wt % to about 45 wt %, from about 10 wt % to about 45 wt %, from about 15 wt % to about 45 wt %, from about 15 wt % to about 30 wt %, or from about 15 wt % to about 25 wt %. In some embodiments, the opacifier(s) may be present in the insulative composite in an amount less than about 10 wt %, from about 1 wt % to about 10 wt %, from about 2 wt % to about 10 wt %, from about 3 w % to about 10 wt %, from about 4 wt % to about 10 wt %, from about 5 wt % to about 10 wt %, from about 6 wt % to about 10 wt %. from about 7 wt % to about 10 wt %, from about 8 wt % to about 10 wt %, or from about 9 wt % to about 10 wt %.

### Reinforcement Fiber

In some embodiments, the insulative composite also includes at least one reinforcement fiber. In one embodiment, the reinforcement fiber may be chopped fibers having a size from about 0.1 mm to about 25 mm, from about 0.1 to about 19 mm, from about 0.1 mm to about 15 mm, from about 0.1 mm to about 13 mm, from about 0.1 mm to about 10 mm, from about 0.1 mm to about 7 mm, or from about 0.1 mm to about 5 mm. A variety of reinforcement fibers may be used and may include fibers such as, but not limited to, carbon fibers, glass fibers, aluminoborosilicate fibers, or combinations thereof. In at least one embodiment, the reinforcement fibers are chopped glass fibers. The amount of reinforcement fibers present in the high temperature insulative composite is up to about 25 wt %. In some embodiments, the reinforcement fiber is present in the insulative composite in an amount from about 1 wt % to about 25 wt %, from about 2 wt % to about 20 wt %, from about 3 wt % to about 20 wt %, from about 5 wt % to about 15 wt %, from about 8 wt % to about 15 wt %, from about 9 wt % to about 15 wt %, or from about 10 wt % to about 15 wt %. In some embodiments, the reinforcement fiber is present in an amount from about 1 wt % to about 10 wt %, from about 2 wt % to about 10 wt %, from about 3 wt % to about 10 wt %, from about 4 wt % to about 10 wt %, from about 5 wt % to about 10 wt %, from about 6 wt % to about 10 wt %, from about 7 wt % to about 10 wt %, or from about 8 wt % to about 10 wt %.

### Expandable Microspheres

The insulative composite may further include one or more expandable microspheres (e.g., EXPANCEL®, commercially available from Nouryon Chemicals B.V., The Netherlands). In one embodiment, the insulative composite includes up to about 20 wt % of an expandable polymeric microsphere, such as EXPANCEL®. The expandable microspheres may generally be described as expandable thermoplastic microspheres that encapsulate an expandable gas. In some embodiments, the insulative composite contains expandable microspheres in an amount from about 1 wt % to about 20 wt %, from about 1 wt % to about 15 wt % or from about 1 wt % to about 10 wt %. In some embodiments, the expandable microspheres are present in the insulative composite in an amount from about 1 wt % to about 15 wt %, from about 1 wt % to about 14 wt %, from about 1 wt % to about 13 wt %, from about 1 wt % to about 12 wt %, from about 1 wt % to about 11 wt %, from about 1 wt % to about 10 wt %, from about 1 wt % to about 9 wt %, from about 1 wt % to about 8 wt %, from about 1 wt % to about 7 wt %, from about 1 wt % to about 6 wt %, from about 1 wt % to about 5 wt %, or from about 1 wt % to about 3 wt %. In some embodiments, the expandable microspheres are present in the insulative composite in an amount from about 0.1 wt % to about 10 wt %, about 0.1 wt % to about 9 wt %, from about 0.1 wt % to about 8 wt %, from about 0.1 wt % to about 7 wt %, from about 0.1 wt % to about 6 wt %, from about 0.1 wt % to about 5 wt %, from about 0.1 wt % to about 5 wt %, from about 0.1 wt % to about 4 wt %, from about 0.1 wt % to about 3 wt %, from about 0.1 wt % to about 2 wt %, from about 0.1 wt % to about 1 wt %, from about 0.5 wt % to about 5 wt %, from about 0.5 wt % to about 4 wt %, from about 0.5 wt % to about 3 wt %, from about 0.5 wt % to about 2 wt %, or from about 0.5 wt % to about 1 wt %.

The use of expandable microspheres may reduce the density of the resulting insulative composites, as well as articles including the insulative composite(s). In one embodiment, the insulative composite may have a density ranging from about 0.01 g/cm³ to about 0.40 g/cm³, from about 0.01 g/cm³ to about 0.30 g/cm³ from about 0.01 g/cm³ to about 0.25 g/cm³, or from about 0.05 g/cm³ to about 0.25 g/cm³. Additionally, the insulative composite is compressible, meaning that it can be reduced in total thickness by the application of pressure to the insulative composite. Embodiments of the insulative composite that contain expandible microspheres exhibit greater compressibility at low to moderate compressive stress values, while maintaining compressive stiffness as compressive stress rises to higher values. Compressibility can be tuned in an insulative composite by varying the amounts of expandable microspheres. In addition, a compressible insulative composite can assist in accommodating gaps or spaces generated from variations in individual dimensions when placed in a container or volume of fixed specific dimensions (e.g., battery cells). Insulative composites can also maintain a desirable compressive stress or torque on individual cells as cell dimensions change due to temperature fluctuations and charge-discharge cycles.

### Additional Components

The insulative composite may further include one or more additional components, such as, but not limited to flame retardant materials, additional polymers, opacifier(s) (as discussed above), intumescent material(s), oxygen scavenger(s), dyes, plasticizers, and thickeners.

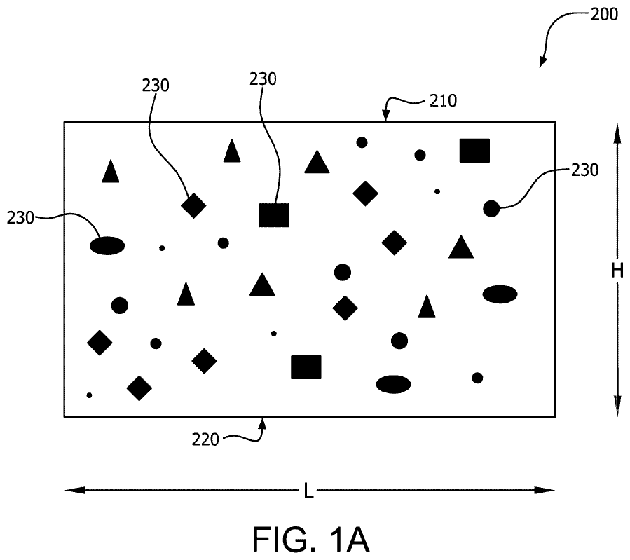

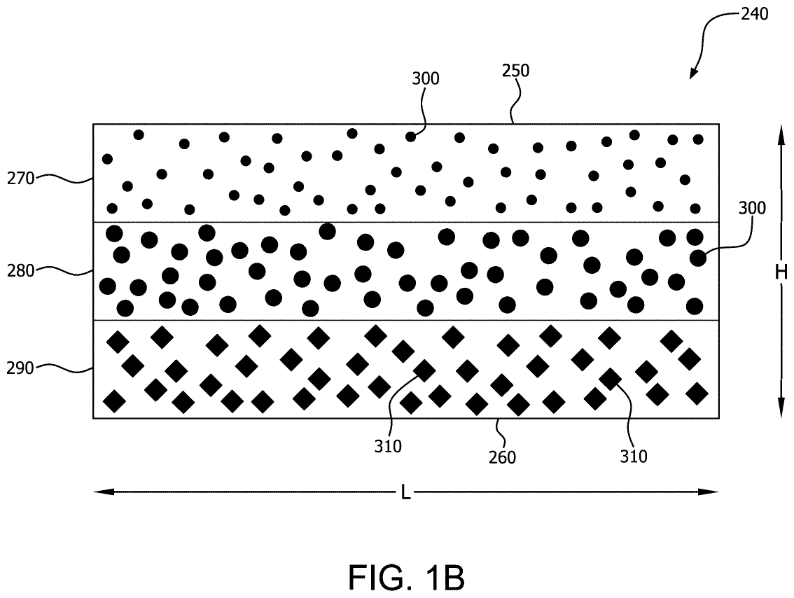

Looking at FIG. 1A, the insulative particle(s), the opacifier(s), the reinforcement fibers, the expandable microspheres, and/or the additional components, hereinafter grouped as “particulate components [230]” are durably enmeshed within the microstructure of the fibrillated polymer matrix of the insulative composite. As described above, the phrase “durably enmeshed” is meant to denote that the insulative particles and the additional particulate components (e.g., insulative particles, reinforcement fibers, expandable microspheres, and opacifier(s)) of the high temperature insulative composite are non-covalently immobilized within the fibrillated polymer matrix. No separate binder is present to fix the particulate components within the fibrillated polymer matrix. Additionally, it is to be appreciated that the insulative particles and the additional particulate components are located through the thickness of the fibrillated polymer matrix. The insulative particles and the additional particulate components are located fairly equally throughout the microstructure of the fibrillated polymer membrane of the insulative composite [200]. The insulative composite [200] has a challenge side [210], a protected side [220], a height (H) and a length (L).

The insulative composite may be formed of a composite (e.g., one layer) as generally depicted in FIG. 1A or optionally as a multi-layer stack insulative composite (e.g., multiple, individual layers of the insulative composite) as generally depicted in FIG. 1B. In a multi-layer stack insulative composite, each layer may have therein insulative particles and/or an additional particulate component(s) that has a different chemical composition, a different particle size, a different particle size distribution, or a different particle distribution. In one embodiment, opacifiers having differing properties such as composition, size, and/or shape may be distributed in various layers throughout the thickness of the insulative composite, such as is described in Hu et al. (Radiative Characteristics of Opacifier Loaded Silica Aerogel Composites, 2013).

In the multi-layer stack insulative composite illustrated in FIG. 1B, for ease of illustration, of the additional particulate components present in the multi-layer stack insulative composite, only the opacifiers are depicted. FIG. 1B is a schematic cross-section of one embodiment of a multi-layer stack insulative composite having multiple layers. As shown, the multi-layer stack insulative composite [240] has a height (H) and a length (L). The multi-layer stack insulative composite [240] contains a challenge side and a protected side [260].

In the embodiment depicted in FIG. 1B, the height (H) is divided into three layers, namely Layer A [270], Layer B [280], and Layer C [290]. In some embodiments, Layer A [270], Layer B [280], and Layer C [290] may contain the same type of opacifier but with different size distributions. In other embodiments, Layer A [270], Layer B [280], and Layer C [290] may contain different types of opacifier with different size distributions. As shown in FIG. 1B, Layer A [270] has a first opacifier [300] with a first size distribution, Layer B [280] has a first opacifier [300] with a second size distribution, and Layer C [290] has a second opacifier [310] with the first size distribution. The first opacifier [300] may silicon carbide and the second opacifier [310] may be carbon black, although this is exemplary in nature and is not meant to restrict the purview of this disclosure. In some embodiments, the additional particulate components may be different in each layer, or only in certain layers. In other embodiments, the particulate components are the same in each layer, but each layer has a different size distribution. Thus, each layer in a multi-layer stack insulative composite may include insulative particles and/or one or more additional particulate components that have a different chemical composition, a different particle size, and/or a different particle size distribution within each layer (or only within certain layers).

In forming a multi-layer stack insulative composite, each layer is separately formed as described below and then layered or stacked upon each other in a manner to obtain a desired orientation of the layers in the multi-layer stack insulative composite. The layers may be bound to each other in any conventional manner such as laminating, adhering, or otherwise bonding to form the multi-layer insulative composite.

### Fibrillated Polymer Matrix

The use of a fibrillatable polymer to create the insulative composites enables the formation of thin and flexible form factors (e.g., films, sheets, and tubes) having the insulative particles and other additional particulate components durably enmeshed (e.g., non-covalently bound; have little or no dusting) and distributed within the fibrillated polymer matrix. It is to be appreciated that there is no imbibing step to introduce the insulative particles and additional particulate components into the fibrillated polymer matrix. Thus, the insulative particles and additional particulate components within the high temperature insulative composite are durably enmeshed within the fibrillated polymer matrix. Thin and flexible form factors are important to many applications where a high temperature event may occur, such as, for example, capacitors, heating elements, high energy batteries, etc. It is to be even upon complete volatilization of the fibrillated polymer matrix within the insulative composite, the remaining components provide a separate matrix that provides a protective effect. This is due at least to the additional particulate components being more thermally stable relative to the fibrillated polymer matrix. In at least one embodiment, the insulative composites have a thickness of about 5 mm or less, about 4 mm or less, about 3 mm or less, about 2 mm or less, or about 1 mm or less. In some embodiments, the insulative composite has a thickness from about 1 mm to about 5 mm, from about 1 mm to about 4 mm, from about 1 mm to about 3 mm, from about 1 mm to about 2 mm, from about 0.01 mm to about 5 mm, from about 0.01 mm to about 4 mm, from about 0.1 mm to about 3 mm, from about 0.1 mm to about 2.5 mm, from about 0.1 mm to about 2 mm, from about 0.1 mm to about 1.5 mm, or from about 0.1 mm to about 1 mm. In still other embodiments, the thickness of the insulative composite is less than or equal to 1 mm.

As used herein, the terms “fibrillating” and “fibrillatable” refer to the ability of a polymer to form a node and fibril microstructure or a microstructure substantially comprised of only fibrils when exposed to sufficient shear. In some embodiments, the fibrillated polymer may be mixed, such as, for example, by wet mixing, by dispersion, or by coagulation. Time and temperatures at which the shearing and/or mixing occurs varies with particle size, material used, and the amount of particles being mixed and is easily determined by those of skill in the art.

A variety of fibrillatable polymers may be used to obtain the insulative composites. The use of fibrillatable polymers as a binder for the insulative composite provides both strength (and the ability to form thin materials), conformability, and compressibility while durably enmeshing the particulate components into a cohesive shape. It is to be noted that the insulative particles and the additional particulate components (the expandable microspheres, the opacifier, and the reinforcement fibers) are considered as “particulate components” herein. Blending the fibrillatable polymer particles and particulate components in the insulative composite with sufficient shear during the blending/forming process results in a fibrillated polymeric matrix (nodes interconnected by fibrils or a microstructure of substantially only fibrils) having the particulate materials durably enmeshed therein.

The decomposition temperature of the fibrillated polymer matrix varies according to the polymer. In one aspect, the fibrillated polymer matrix is prepared from a fibrillatable polymer particle of a polyolefin, a fluoropolymer, a polyurethane, a polyester, a polyamide, polylactic acid, or any combination thereof. Non-limiting examples of fibrillatable polymers include, but are not limited to, polytetrafluoroethylene (PTFE) (U.S. Pat. No. 3,315,020 to Gore; U.S. Pat. No. 3,953,566 to Gore; and U.S. Pat. No. 7,083,225 to Baille), expanded polytetrafluoroethylene (ePTFE), ultrahigh molecular weight polyethylene (UHMWPE) (U.S. Pat. No. 10,577,468 to Sbriglia), polylactic acid (PLLA; U.S. Pat. No. 9,732,184 to Sbriglia), copolymers of vinylidene fluoride with tetrafluoroethylene or trifluoroethylene (e.g. VDF-co-(TFE or TrFE) polymers; U.S. Pat. No. 10,266,670 to Sbriglia), poly (ethylene tetrafluoroethylene) (ETFE; U.S. Pat. No. 9,932,429 to Sbriglia), polyparaxylxylene (PPX; U.S. Publication No. 2016/0032069 to Sbriglia), and polytetrafluoroethylene (PTFE; U.S. Pat. No. 3,315,020 to Gore; U.S. Pat. No. 3,953,566 to Gore; and U.S. Pat. No. 7,083,225 to Baille). In one embodiment, the fibrillated polymer is fibrillated PTFE made from PTFE fine powder particles that are non-melt processible (i.e., the melt flow viscosity is too high for melt extrusion and requires high shear blending and/or paste processing for form the fibrillated polymer matrix) (see, e.g. Expanded PTFE Applications Handbook—Technology, Manufacturing and Applications, Ebnesajjad, Sina, (1997), Elsevier, Cambridge, MA).

As used herein, the term “PTFE” includes homopolymer PTFE and modified PTFE resins (e.g., having up to 5 wt %, up to 4 wt %, up to 3 wt % up to 2 wt %, or up to 1 wt % of one or more ethylenic comonomers including, but not limited to perfluoroalkyl ethylene (e.g. perfluorobutyl ethylene; U.S. Pat. No. 7,083,225 to Baille), hexafluoropropylene, perfluoroalkyl vinyl ether (C1-C8 alkyl; such as perfluoro methyl vinyl ether, perfluoro ethyl vinyl ether, perfluoro propyl vinyl ether, perfluoro octyl vinyl ether, etc.). PTFE is also meant to include, expanded modified PTFE and expanded copolymers of PTFE, such as, for example, those described in U.S. Pat. No. 5,708,044 to Branca, U.S. Pat. No. 6,541,589 to Baillie, U.S. Pat. No. 7,531,611 to Sabol et al., U.S. Pat. No. 8,637,144 to Ford, and U.S. Pat. No. 9,139,669 to Xu et al.

Suitable fibrillated fluoropolymers may also include fibrillatable copolymers and terpolymers of tetrafluoroethylene (TFE) with comonomers such as vinylidene fluoride (VDF), vinylidene difluoride, hexafluoroisobutylene (HFIB), trifluoroethylene (TrFE), chlorotrifluoroethylene (CTFE), hexafluoropropylene (HFP), fluorodioxole or fluorodioxalane (e.g., U.S. Pat. No. 9,040,646 to Ford), and ethylene (e.g., ethylene tetrafluoroethylene (ETFE; U.S. Pat. No. 9,932,429; supra). All of the above-identified polymers will at least partially or fully volatilize (degrade) when exposed to a high temperature event having a temperature of at least 800° C.

In some embodiments, the fibrillated polymer matrix is a polytetrafluoroethylene (PTFE) matrix having a node and fibril microstructure or a microstructure containing substantially only fibrils. The fibrils of the PTFE particles interconnect with other PTFE fibrils and/or to nodes to form a net within and around the particulate components, effectively immobilizing and durably enmeshing them within the fibrillated polymer matrix.

The amount of fibrillated polymer present in the insulative composite is about 60 wt % or less, about 50 wt % or less, about 40 wt % or less, about 30 wt % or less, about 20 wt % or less, or about 10 wt % or less. The fibrillated polymer may be present in the insulative composite in an amount from about 1 wt % to about 60 wt %, from about 1 wt % to about 50 wt %, from about 1 wt % to about 40 wt %, from about 1 wt % to about 30 wt %, from about 1 wt % to about 25 wt %, from about 1 wt % to about 20%, from about 1 wt % to about 15 wt %, from about 1 wt % to about 15 wt %, or from about 1 wt % to about 10 wt %. In other embodiments, the amount of fibrillated polymer ranges from about 5 wt % to about 30 wt %, from about 10 wt % to about 25 wt %, from about 1 wt % to about 20 wt %, from about 1 wt % to about 15 wt %, from about 1 wt % to about 10 wt %, or from about 1 wt % to about 5 wt %.

In some embodiments, the porous fibrillated polymer matrix may be formed by dry mixing the fibrillatable polymer particles with the other particulate components in a manner such as is generally taught in U.S. Publication No. 2010/0119699 to Zhong, et al., U.S. Pat. No. 7,118,801 to Ristic-Lehmann et al., U.S. Pat. No. 5,849,235 to Sassa, et al., U.S. Pat. No. 6,218,000 to Rudolf, et al., or U.S. Pat. No. 4,985,296 to Mortimer, Jr.

In one embodiment, a coagulum may be prepared using the general methodology described in U.S. Pat. No. 7,118,801 to Ristic-Lehmann et al. The general method of preparing the coagulum includes mixing an aqueous dispersion of particulate component particles (insulative particles, opacifiers, reinforcement fibers and/or expandable microsphere) with a fibrillatable polymer particle dispersion and then coagulating the mixture by agitation or by the addition of coagulating agents. The resulting co-coagulation of the polymer particles in the presence of the insulative particles and other particulate components creates an intimate blend of the fibrillatable polymer particles, the insulative particles, and the other particulate components (i.e., insulating material). The insulating material is drained and dried in a convection oven at about 433 K. Depending on the type of wetting agent used, the dried insulating material may be in the form of loosely bound powder or in the form of soft cakes that may then be chilled and ground to obtain the insulating material in the form of a powder. The powdered insulating material may then be blended with a suitable hydrocarbon lubricant (for example, an isoparaffinic lubricant (e.g., ISOPAR K®, available from Exxon Mobil Corp., Houston, Texas)) for subsequent mechanical processing steps to induce fibrillation and the formation of a cohesive matrix into a desired form factor, such as a tape, sheet or putty. The mechanical processing steps may include one or more steps of high shear mixing, pressing, calendaring, and combinations thereof to form the insulative composite having a fibrillated polymer matrix. At least one drying step is included to remove the hydrocarbon lubricant.

The insulative composite can be formed into relative thin form factors (e.g., sheets). Thin form factors of the high temperature insulative composite are attractive for use in electronic devices and/or batteries where an undesirable high temperature thermal event may occur. In one embodiment, the insulative composite is formed into a shaped putty, tube, tape or sheet having an average thickness (or tube wall thickness in the instance of a tube) of less than about 5 mm, about 4 mm or less, about 3 mm or less, about 2 mm or less or about 1 mm or less.

### Thermally Insulative Articles Including an Insulative Composite

In one embodiment, a thermally insulative article includes a first component that is capable of generating a high temperature event (i.e., a first temperature), a second component to be protected against exposure to the first temperature caused by the high temperature event, and an insulative composite. The insulative component is positioned between the first component and the second component. The insulative component may be in the form of a tube, sheet, or film. A first side of the insulative component may be oriented toward the first component and a second side of the insulative component may be oriented toward the second component. In some embodiments, the insulative composite has a thermal conductivity of no more than 25 milliwatts per meter Kelvin (Mw/m K) at atmospheric conditions (298.15 K and 101.3 kPa).

The thermally insulative article may also include one or more support material in the form of supportive layer(s) on one or more sides of the insulative composite. In one embodiment, the support layer(s) is a polymer layer, a woven layer, a knit layer, a non-woven layer, or any combination thereof. The polymer layer can be a nonporous layer, a porous layer, a microporous layer, and any combination thereof. Non-limiting additional support layers include a fluoropolymer membrane (e.g., polytetrafluoroethylene membrane), an expanded fluoropolymer membrane (e.g., expanded polytetrafluoroethylene membrane), a polyolefin membrane (e.g., polyethylene membrane), a metal film, electrical insulation, an adhesive layer, or any combination thereof. Support layer(s) may be included in the thermally insulative article by laminating, adhering, or otherwise bonding one or more support layers to the high temperature insulative composite. For example, the insulative composite may be in the form of a sheet or a film having a first side and a second side, where the thickness is less than the width and/or length directions. One or more support layers can be adhered or otherwise bonded or affixed to the first side, to the second side or to both the first and the second side of the insulative composite.

The one or more support layers can be adhered or otherwise bonded or affixed to the insulative composite using an adhesive, welding, calendering, coating, or any combination thereof. In some embodiments, the thermally insulative article can include multiple layers. For example, the insulative composite can have a layer of expanded PTFE bonded to one or both sides, resulting in an insulative composite having a 2-layer or a 3-layer structure. One or more textile layers, for example, a woven, a knit, a non-woven or any combination thereof, may be adhered or otherwise bonded or affixed to the insulative composite. For example, an adhesive may be applied to the insulative composite, to the textile or to both in a continuous or a discontinuous manner, as is well-known in the art.

The textile layer(s) can be a woven, a knit, a non-woven or any combination thereof. In some embodiments, the woven, knit or non-woven textile may be a flame resistant woven, a flame-resistant knit, or a flame-resistant non-woven textile. Suitable textile layers are well-known in the art and may include elastic and non-elastic textiles, such as, for example, LYCRA®, polyurethane, polyester, polyamide, acrylic, cotton, wool, silk, linen, rayon, flax, jute, flame resistant textiles, such as, for example, NOMEX® aramid (available from Du Pont, Wilmington, DE), aramids, flame resistant cotton, polybenzimidazole, poly p-phenylene-2,6-bezobisoxazole, flame resistant rayon, modacrylics, modacrylic blend, polyamine, carbon, fiberglass or any combination thereof.

### Lithium Ion Battery

In some embodiments, the insulative composite is used as an insulative and protective barrier layer in a high energy battery such as a multi-cell lithium-ion battery. In one aspect, the insulative and protective barrier is used to at least partially or fully enclose or separate one or more cells in the battery or the battery itself. In another embodiment, the battery cell is fully enclosed by the insulative composite. The insulative composite may also be used in module or pack insulation to prevent the propagation of thermal energy or the harmful effects of propagation that may occur when the thermal energy propagates to the opposing side of the insulative component.

Other embodiments in which the insulative composite may be utilized include, but are not limited to, lithium cells used in electrification of aircraft and drones, lithium cells used for residential energy storage (e.g., solar or wind energy storage), lithium cells used for energy backup systems for buildings and critical infrastructure, cells used for computer power back-up systems or uninterruptable power systems (UPS), cells used in electric marine vehicles, drones, and unmanned aerial vehicle (UAV), cells used in personal vehicles (e.g., scooters), and cells used in emergency medical backup systems.

The disclosure of this application has been described above both generically and with regard to specific embodiments. It will be apparent to those skilled in the art that various modifications and variations of the disclosure can be made without departing from the spirit or scope of the disclosure, as defined in the appended claims.

### Test Methods

### Density Measurement

Density of the composite insulation was calculated via the formula density=mass/volume. The mass of a 1.5″ diameter punch was determined via a Sartorius Entris 224-1S analytical balance. Thickness of the sample was measured with a Mitutoyo Litematic VI-50 contact gauge with a sample placed between two glass slides of known thickness and a probe force of 0.2N. Three samples were tested, recorded, and then averaged to provide an averaged value of the density.

### Tensile Strength

Tensile Strength of the membrane was measured using an INSTRON® 5565 tensile test machine equipped with flat-faced grips and a 0.445 kN load cell. The gauge length was 6.35 cm, and the crosshead speed was 50.8 cm/min (strain rate=13.3%/sec). To ensure comparable results, the laboratory temperature was maintained between 68° F. (20° C.) and 72° F. (22.2° C.) to ensure comparable results. Data was discarded if the sample broke at the grip interface.

For longitudinal (length direction) tensile strength measurements, the larger dimension of the sample was oriented in the machine, or “down web,” direction. For the transverse tensile strength measurements, the larger dimension of the sample was oriented perpendicular to the machine direction, also known as the “cross web” direction. The thickness of the samples was then measured using a Mitutoyo 547-400 Absolute snap gauge. The samples were then tested individually on the tensile tester. Three different sections of each sample were measured. The average of the three-maximum load (i.e., the peak force) measurements was used.

The longitudinal and transverse tensile strengths were calculated using the following equation:

Tensile strength=maximum load/cross-section area.

The average of three cross-web measurements was recorded as the longitudinal and transverse tensile strengths.

### Thickness

Sample thickness was measured with the integrated thickness measurement of the thermal conductivity instrument. (Laser Comp Model Fox 314 Laser Comp Saugus, MA). The result of a single measurement was recorded.

### Room Temperature Thermal Conductivity

Thermal conductivity was also measured without compressing the sample. The samples were measured with a Laser Comp Model Fox 314 thermal conductivity analyzer. (Laser Comp Saugus, MA). The results of a single measurement were recorded. Two 8″×8″ (20.3 cm×20.3 cm) samples were stacked and measured with a delta T of 20 degrees, with the hot and cold plates at 35° C. and 15° C., respectively.

### Compression Set Testing

Compression stress—strain characteristics and compressive set behavior were determined using ASTM D395-18 with the exception that the thickness 1 mm and the diameter of the sample was 3.08 cm (i.e., an Instron 5565 testing frame utilizing a 1 kN load cell; 5.08 cm diameter top compression platen; a 12.7 cm diameter bottom self-aligning, spherical seated compression plate; a LVDT deflection sensor fixed to the top compression platen and in contact with the bottom compression plate; a insulative composite of a diameter of 3.08 cm). Compressive set behavior determined at 50% compressive displacement, held for 30 minutes, and was calculated using the following formula:

$$\begin{matrix}Cs = ( to - ti / to ) * 100 \\ {C}_{s} = ( \frac{{t}_{o} - {t}_{i}}{{t}_{o}} ) * 100 ,\end{matrix}$$

where t₀ refers to the original thickness and tᵢ refers to the final thickness. The thickness of the sample was measured using a Mitutoyo Litematic VI-50 contact gauge. The sample was sandwiched between glass slides and then contacted by the probe head under a force 0.2 N. The probe head equilibrated for 30 seconds after the 0.2 N contact.

For compressive stress-strain behavior, compression was then initiated at a displacement rate of 0.5 mm/min, until a displacement of 50% of the measured thickness was achieved. Once 50% of the original thickness was met, the displacement of the plates was fixed for a period between 30 minutes and 24 hours, followed by the release of the displacement plates. FIG. 4 is a graphical illustration of compressive engineering stress vs. thickness normalized compressive deflection:

$$\begin{matrix}( xi - to / to ) * 100 \\ ( \frac{{x}_{i} - {t}_{o}}{{t}_{o}} ) * 100 ,\end{matrix}$$

where xᵢ refers to the compressive displacement, and t₀ refers to the original thickness, for samples 1 through 4 of Example 2. This demonstrates that the ability to tune compressive behavior of the insulative composite such that at a fixed compressive stress a wide range of compressive deflection is feasible.

### Protective Heat Propagation Barrier Assay

The following assay was used to measure the insulative barrier performance of insulative composites when exposed to a heated mass having a temperature sufficient to partially or completely volatilize (e.g., degrade) the fibrillated polymer within the insulative composite. A thin sheet (˜1 mm) of the insulative composite was compressively contacted with an ˜800° C. stainless steel block (“heat accumulator”), having dimensions of: height 5.5 inches (approximately 14.0 cm); width 3.5 inches (approximately 7.6 cm); thickness 0.5 inches (approximately 1.27 cm). The composite exhibited a density of 7999.4 kg/m³, a volumetric heat capacity of 617.6 J/kgK, and a calculated sensible energy of 600 kJ. The side of the test material placed in contact with the heated mass is referred to herein as the “challenge side”. The maximum temperature observed post contact on the opposing side (herein also referred to as the “protected side”) of the test material was recorded over a period of time ranging from 10 to 60 minutes. Thin sheets (˜1 mm thick) of insulative composites capable of limiting the maximum temperature observed to 215° C. or less were considered suitable for use as an insulative composite.

One side (“challenge side”) of a thin rectangular sheet (˜1 mm thick) of test material was placed in contact under compression with a rectangular stainless-steel block (referred to herein as the “heat accumulator”) heated to a target temperature of approximately 800° C. Two identical samples were placed on opposing sides of the rectangular heat accumulator to ensure symmetric heat dissipation. Type K thermocouples were used to measure the temperature of the heat accumulator as well as the temperature on the opposing side of each test sample. The average temperature on the opposing side of each test sample was recorded continually over time (10 to 60 minutes) post contact with the heat accumulator and the maximum average temperature observed during the contact period was recorded.

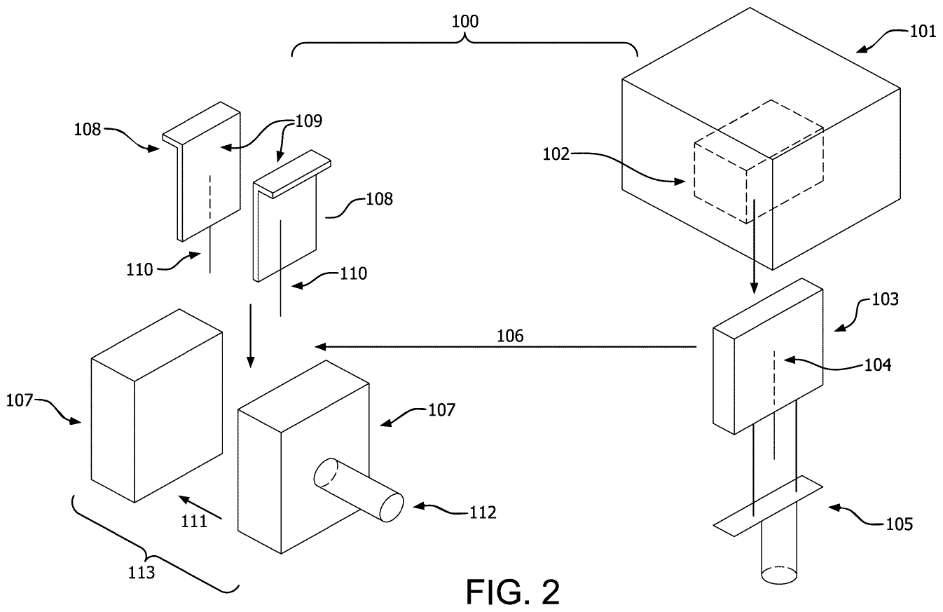

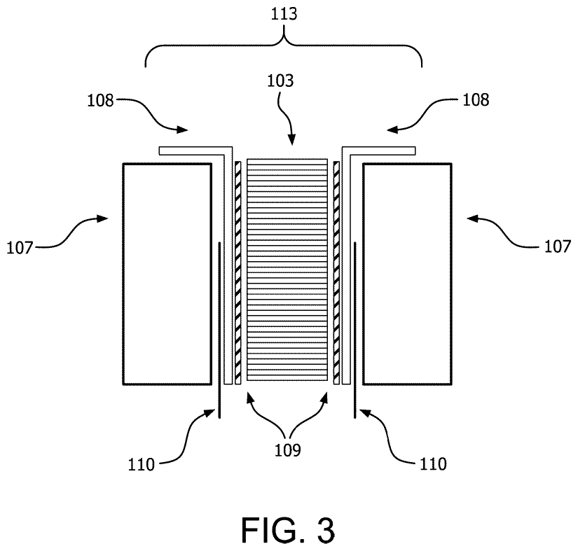

Referring to FIGS. 2 and 3 (FIG. 3 is a side view of elements within of the contact compression zone [113] during the testing assay), the testing system [100] comprised of a high temperature furnace [101] configured with an opening [102] to accept a rectangular 304 stainless steel block 5.5 inches×3.5 inches×0.375 inch (approximately 14.0 cm×7.6 cm×0.95 cm, respectively) (“heat accumulator”) is depicted. The total mass of the heat accumulator was 905 grams. The heat accumulator was heated in the furnace [101] to a temperature of approximately 800° C. The heat accumulator volume, material properties, volumetric heat capacity, and thermal conductivity were chosen to afford a specific sensible energy output that was representative of the energy released by a lithium-ion battery cell failure. A type-K thermocouple [104] (bonded to the heat accumulator [103] using a thermally stable and conductive ceramic epoxy) was used to measure the temperature of the heat accumulator. A pneumatically controlled transfer system [105] was used to rapidly remove the approximately 800° C. heat accumulator [103] from the furnace [101] and place it within contact compression zone [113].

Test samples were adhered to the surfaces of 1 mm thick 4-inch×6-inch (approximately 10.16 cm×15.25 cm; respectively) aluminum support sheets [108]. The aluminum sheets [108] were configured with small 90° flanges to aid in holding the supported test samples on the compression plates [107]. Type-K thermocouples [110] were placed into a groove having a depth of 0.5 mm, located on the opposing face of the thin aluminum support sheet [108] to the test sample [109], and were embedded with thermally stable conductive ceramic epoxy such that the temperatures on the opposing sides (i.e., the sides not in direct contact with the heat accumulator) of the test samples could be measured while maintaining compressive planarity.

A contact compression zone [113] having two flat compression plates [107] was used to compressively contact the heat accumulator [103] against one side of each test sample [109]. The plates [107] consisted of a machined stainless-steel backer plate attached to a MACOR® machinable glass ceramic front plate (Corning Inc., Corning, NY). The thin aluminum sheets containing the supported test samples [109] were placed on the compression plates [107]. The compression plates [107] were attached to a pneumatically controlled compression system [112] used to bring the supported test samples into contact with the heat accumulator [103].

To initiate a test, the approximately 800° C. heat accumulator was rapidly transferred from the furnace [101] and placed between the two supported test samples. The compression system [112] was used to rapidly move the compression plates (with the supported test samples) together [111], compressively contacting (pressure ˜42,300 Pa) the test samples against the heat accumulator. FIG. 3 is a side view illustrating the orientation of elements within the contact compression zone [113] upon initiation of the test (time 0). Type-K thermocouples [110] recorded the temperature on the opposite side of each test sample over time. The temperature from the heat accumulator and temperatures in the thin aluminum support sheets [109] were recorded over a defined time (type 10 min to 60 minutes). The maximum average temperate observed over the defined contact period was recorded. FIG. 4 is a graph illustrating a representative plot of the heat accumulator temperature and the temperature measured on the opposing sides of the composite insulation sample over 45 minutes post contact.

### EXAMPLES

### Example 1

### Insulative Composite

Fibrillatable homopolymer polytetrafluoroethylene (PTFE) fine powder particles (12 wt %), 50 wt % fumed silica particles (Evonik AEROSIL® fumed silica; Evonik Corporation, Parsippany, NJ), 30 wt % silicon carbide particles (opacifier) (F1200 Silicon carbide, Washington Mills North Grafton, Inc., North Grafton, MA), and 8 wt % chopped glass fibers (#30 E-Glass; ¼″ cut length (6.4 mm); fiber diameter 13 microns) (Fibre Glast Developments Corp., Brookville, OH) were blended with a mineral spirit lubricant. The blend was then formed into a tape and dried to form an insulative composite in the form of a sheet as generally taught in U.S. Pat. No. 7,868,083 to Ristic-Lehmann et al. The sheet had a thickness of approximately 1 mm and contained the fibrillatable PTFE particles, the fumed silica particles, the chopped glass fibers, and the silicon carbide particles durably enmeshed and immobilized within the fibrillated PTFE matrix.

The insulative composite sample was tested using the Protective Heat Propagation Barrier Assay described above. The insulative composite sample was cut into two pieces and these two sample pieces of the insulative composite were tested by placing each sample piece on each side of the heat accumulator in the high temp test fixture. The maximum temperature of the two sample pieces was observed measured, averaged, and recorded. A compositional break-down of the test samples including thickness, density, and the respective performance as an insulative composite (i.e., the average max temp observed) is provided in Table 1. It is to be appreciated that the weight percentages are reported relative to the total weight of the final insulative composite.

### Insulative Composite

### Example 2

Fibrillatable homopolymer ultra high molecular weight polyethylene (UHMWPE) fine powder particles (8.5 wt %), 52.2 wt % fumed silica particles (Evonik AEROSIL® fumed silica; Evonik Corporation, Parsippany, NJ), 31.3 wt % silicon carbide particles (opacifier) (F1200 Silicon carbide, Washington Mills North Grafton, Inc., North Grafton, MA), and 8 wt % chopped glass fibers (#30 E-Glass; ¼″ cut length (6.4 mm); fiber diameter 13 microns) (Fibre Glast Developments Corp., Brookville, OH) were blended with a mineral spirit lubricant. The blend was then formed into a tape and dried to form a high temperature insulative composite in the form of a sheet as generally taught in U.S. Pat. No. 7,868,083 to Ristic-Lehmann et al. The high temperature sheet had a thickness of approximately 1 mm and contained the fibrillatable UHMWPE particles, the fumed silica particles, the chopped glass fibers, and the silicon carbide particles durably enmeshed and immobilized within the fibrillated UHMWPE matrix.

The high temperature insulative composite sample was tested using the Protective Heat Propagation Barrier Assay described above. Two samples were tested. The maximum temperature of the two samples was observed measured, averaged, and recorded. A compositional break-down of the test samples including thickness, density, and the respective performance as a high temperature insulative composite (i.e., the average max temp observed) is provided in Table 1. It is to be appreciated that the weight percentages are reported relative to the total weight of the final high temperature insulative composite.

TABLE 1
High Temperature Insulative Composite Sample Examples
1 and 2 and Corresponding Thermal Performance

| | Component Mass | | | | | | Average |
|---|---|---|---|---|---|---|---|
| | Fraction (wt %) | | | | | | Maximum |
| | | Fumed | | | Thickness | Density | Temperature |
| Sample # | Binder | Silica | Fiber | Opacifier | (mm) | (g/cm³) | (° C.) |
| Example #1 | 12 | 50 | 8 | 30 | 1.07 | 0.644 | 162 |
| Example #2 | 8.5 | 52.2 | 8 | 31.3 | 1.02 | 0.371 | 184 |

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1. An insulative composite comprising:
50 wt % or less of a fibrillated polymer matrix;
more than 40 wt % insulative particles, wherein the insulative particles are selected from fumed silica, amorphous silica, colloidal silica, precipitated silica, fused silica, silica gel, silica xerogel, silicates, fumed metal oxides, and combinations thereof; and
greater than about 1 wt % of a combined total of additional particulate components selected from one or more opacifier, one or more reinforcement fiber, one or more expandable microsphere, and any combination thereof,
wherein the weight percent is based on the total weight of the final insulative composite, and
wherein the insulative particles and the additional particulate components are durably enmeshed within the fibrillated polymer matrix.

2. (canceled)

3. The insulative composite of claim 1, wherein the insulative composite is in the form of a tube, tape or sheet having a thickness or a tube wall thickness of 5 mm or less.

4. The insulative composite of claim 1, wherein the fibrillated polymer matrix comprises a polyolefin, an ultrahigh molecular weight polyethylene, a fluoropolymer, polytetrafluoroethylene, expanded polytetrafluoroethylene, a polyurethane, a polyester, a polyamide, or any combination thereof.

5. The insulative composite of claim 1, wherein the polymer is polytetrafluorethylene (ePTFE), an ultra-high molecular weight polyethylene (UHMWPE) or a combination thereof.

6. The insulative composite of claim 1, wherein the combined total of additional particulate components comprises greater than 1 wt % of one or more opacifier.

7. The insulative composite of claim 1, wherein the additional particulate components comprise up to 30 wt % of the expandable microsphere.

8. The insulative composite of claim 1, wherein the opacifier is selected from carbon black, titanium dioxide, aluminum oxide, zirconium dioxide, iron oxides, silicon carbide, molybdenum silicide, manganese oxide, a polydialkylsiloxane where the alkyl groups contain 1 to 7 carbon atoms, or any combination thereof.

9. The insulative composite of claim 1, wherein the one or more reinforcement fibers comprise carbon fibers, glass fibers, aluminoborosilicate fibers, or a combination thereof.

10. An insulative composite comprising:
less than 50 wt % of a fibrillated polymer matrix;
less than 80 wt % of insulative particles, wherein the insulative particles are selected from fumed silica, amorphous silica, colloidal silica, precipitated silica, fused silica, silica gel, silica xerogel, silicates, fumed metal oxides, and combinations thereof;
greater than about 1 wt % of at least one opacifier;
up to 25 wt % reinforcement fibers; and
less than 20 wt % expandable microspheres,
wherein the weight percent is based on the total weight of the insulative composite article in a final state, and
wherein the insulative particles and the additional particulate components are durably enmeshed within the fibrillated polymer matrix.

11. (canceled)

12. The insulative composite of claim 10, wherein the insulative composite in the form of a tube, tape or sheet having a thickness or a tube wall thickness of 5 mm or less.

13. The insulative composite of claim 10, wherein the fibrillated polymer matrix comprises a polyolefin, an ultrahigh molecular weight polyethylene, a fluoropolymer, polytetrafluoroethylene, expanded polytetrafluoroethylene, a polyurethane, a polyester, a polyamide, or any combination thereof.

14. The insulative composite of claim 10, wherein the polymer is expanded polytetrafluorethylene (ePTFE), an ultra-high molecular weight polyethylene or a combination thereof.

15. The insulative composite of claim 10, wherein the combined total of additional particulate components comprises greater than 1 wt % of one or more opacifier.

16. The insulative composite of claim 10, wherein the additional particulate components comprise up to 30 wt % of expandable microspheres.

17. The insulative composite of claim 10, wherein the opacifier is selected from carbon black, titanium dioxide, aluminum oxide, zirconium dioxide, iron oxides, silicon carbide, molybdenum silicide, manganese oxide, a polydialkylsiloxane where the alkyl groups contain 1 to 4 carbon atoms, or any combination thereof.

18. The insulative composite of claim 10, wherein the one or more reinforcement fibers comprise carbon fibers, glass fibers, aluminoborosilicate fibers, or a combination thereof.

19. An article comprising the insulative composite of claim 1.

20. An article comprising the insulative composite of claim 10.

21. (canceled)

22. (canceled)

23. An article comprising:
a first component capable of a generating a high temperature event comprising a first temperature;
a second component to be protected against exposure to the first temperature; and
an insulative composite positioned between the first element and the second element, the insulative composite having a first side oriented toward the first component and an opposing side oriented towards the second component; the insulative composite comprising:
greater than or equal to about 40 wt % insulative particles, wherein the insulative particles are selected from fumed silica, amorphous silica, colloidal silica, precipitated silica, fused silica, silica gel, silica xerogel, silicates, fumed metal oxides, and combinations thereof;
less than or equal to about 60 wt % of a fibrillated polymer matrix; and
from 1 wt % to 45 wt % of one or more additional particulate components selected from one or more opacifiers, one or more reinforcement fibers, one or more expandable microspheres, and any combination thereof,
wherein the weight percent is based on the total weight percent of the insulative composite in a final state; and
wherein the insulative particles and the additional particulate components are durably enmeshed within the fibrillated polymer matrix.

24. The article of any one of claim 23, wherein the insulative particles are fumed silica particles.

25. (canceled)

26. (canceled)

27. (canceled)
